(19) United States
(12) Patent Application Publication
(10) Pub. No.: US 2007/0143168 A1
(43) Pub. Date: Jun. 21, 2007

(54) Meeting scheduling service

(75) Inventor: Dirk-Jaap Plas, Enschede (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/311,460

(22) Filed: Dec. 19, 2005

(51) Int. Cl. G06F 9/46

(52) U.S. Cl. 705/9

(57) ABSTRACT

A meeting scheduling service is provided that overcomes the problems of accessing scheduling information due to organizational boundaries.

### FIELD OF THE INVENTION

The present invention relates generally to data processing and, in particular, relates to methods and systems for providing a meeting scheduling service.

### BACKGROUND OF THE INVENTION

It is not easy to schedule meetings across organizational boundaries with conventional meeting scheduling and calendar services, because people use different calendar systems or do not have access to each other's calendar information. Conventional approaches require the use of the same calendar application to schedule a meeting. Each calendar application uses its own, often proprietary, way of exchanging calendar information. In addition, conventional approaches assume total access to calendar information, which is commonly not the case when scheduling meetings across organizational boundaries. No standard or convenient way of exchanging calendar information is available. This leads to the exchange of many telephone calls, e-mails, or other communication that is inconvenient to all parties involved and makes scheduling meetings a lengthy and tedious process.

### SUMMARY

Various deficiencies of the prior art are addressed by various exemplary embodiments of the present invention of a meeting scheduling service.

One embodiment is a method for providing a meeting scheduling service. A request to schedule a meeting is received along with at least one proposed date and time for the meeting, and at least one participant for the meeting. Invitations are sent to the participant(s). At least one best date and time for the meeting is determined and provided. Another embodiment is a computer readable medium storing instructions for performing this method.

Another embodiment is a system for providing a meeting scheduling service, including a processor and a storage device. The processor receives a request to schedule a meeting, at least one proposed date and time for the meeting, and at least one participant for the meeting. The processor sends invitations to the participant(s). The processor provides at least one best date and time for the meeting. The storage device is accessible by the processor and stores the proposed date and time for the meeting, the at least one participant for the meeting, the information from the at least one participant, and the at least one best data and time for the meeting.

### BRIEF DESCRIPTION OF THE DRAWINGS

The teachings of the present invention can be readily understood by considering the following detailed description in conjunction with the accompanying drawings, in which:

FIG. 1 is a block diagram illustrating an overview of an exemplary embodiment of a meeting scheduling service;

FIG. 2 is a flow chart illustrating the exemplary embodiment of the meeting scheduling service of FIG. 1 in more detail;

FIG. 3 is a flow chart illustrating an exemplary embodiment of a method for processing a request to organize a meeting;

FIG. 4 is a flow chart illustrating an exemplary embodiment of a method for processing a response from participants;

FIGS. 5A and 5B together form a flow chart illustrating an exemplary embodiment of a method for determining the best suitable date and time; and

FIG. 6 is a high level block diagram showing a computer.

To facilitate understanding, identical reference numerals have been used, where possible, to designate identical elements that are common to the figures.

### DETAILED DESCRIPTION OF THE INVENTION

The invention is primarily described within the general context of exemplary embodiments of methods and systems for providing a meeting scheduling service. However, those skilled in the art and informed by the teachings herein will realize that the invention is applicable generally to scheduling any kind of appointments, reservations, or other scheduled events. The meeting scheduling service may be web-based (e.g., implemented using hypertext markup language (HTML) and hypertext transfer protocol (HTTP)), but can be implemented using many different technologies, such as e-mail (e.g., implemented using simple mail transfer protocol (SMTP), post office protocol (POP), internet message access protocol (IMAP) and the like). The meeting scheduling service may be client-based or server-based or may be implemented using any other kind of computer program application running on any kind of computing device.

One exemplary embodiment is a method of providing a meeting scheduling service. This meeting scheduling service is useful when a meeting organizer is unable to access all the calendar information for a number of participants in order to schedule a meeting conventionally. In this embodiment, the meeting scheduling service is provided on a website that provides space for the meeting organizer to enter information about the meeting (e.g., subject and description), to propose a number of dates and times, and to list the participants and their e-mail addresses. In one embodiment the service is provided through a user interface that is different than a website, such as a feature on a cell phone or through a telephone service. In one embodiment, the dates and times may be entered in many different ways, such as in ranges. In one embodiment, the contact information for participants and the meeting organizer may be entered in many different ways, such as postal mailing addresses.

In this exemplary embodiment, as part of the meeting scheduling service, each participant is sent an invitation for the proposed dates and times. In one embodiment, the invitations are sent in various different ways, such as by telephone. In one embodiment, there are various kinds of participants, such as mandatory, backup, or optional, and participants are invited at various times and in various ways, such as inviting a backup participant when the primary participant is unavailable during the proposed dates and times.

In this exemplary embodiment, as part of the meeting scheduling service, the meeting organizer is informed either when a match is found among the participants for a suitable time or when no suitable time is found for the meeting. The meeting scheduling service allows the meeting organizer to follow the progress of the scheduling process and may inform the participants of an agreed meeting time or receive proposed new meeting times.

In conventional applications, calendar information is exchanged to schedule a meeting across organizational boundaries when calendar information of at least one participant or the meeting organizer is not publicly available. Usually, this information is pulled from a calendar information store. By contrast, in this exemplary embodiment, information is pushed from the various parties in a convenient way. This exemplary embodiment provides a convenient way to exchange calendar information, enabling fast and convenient scheduling of meetings across organizational boundaries.

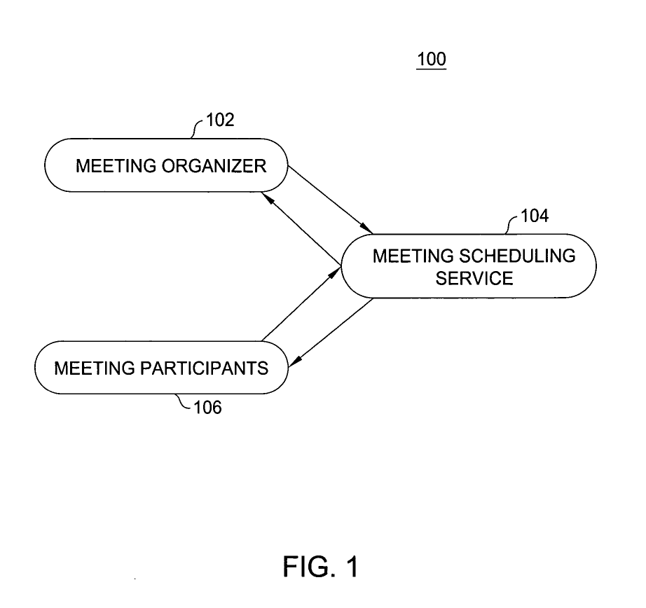

FIG. 1 illustrates an overview of an exemplary embodiment 100 of a meeting scheduling service. In this exemplary embodiment, the meeting organizer 102 visits the meeting scheduling service 104 to organize a meeting by providing meeting information and proposing meeting dates. The meeting scheduling service 104 sends invitations to the meeting participants 106. The participants 106 provide their availability and preferences about the meeting to the meeting scheduling service 104. If a date for the meeting is found by the meeting scheduling service 104, the participants 106 and meeting organizer 102 are notified and the meeting is scheduled. If no date for the meeting is found, the meeting organizer 102 is notified and is given an opportunity to update the meeting information and propose other dates.

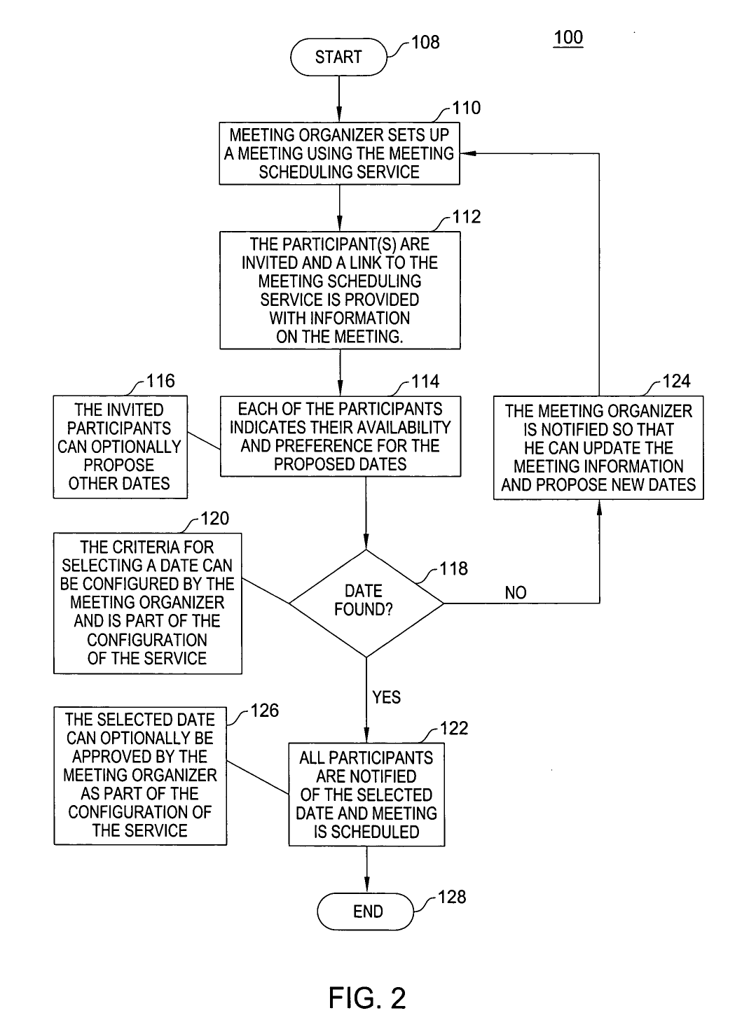

FIG. 2 illustrates the exemplary embodiment 100 of the meeting scheduling service of FIG. 1 in more detail. At 108, the process of using the meeting scheduling service for this exemplary embodiment 100 starts. At 110, the meeting organizer sets up a meeting using the meeting scheduling service. At 112, the participants are invited to use the meeting scheduling service and a link to the meeting scheduling service on the Internet is provided. In one embodiment, the participants may be provided with other related information about the meeting. At 114, each of the participants indicates their availability and preferences for the proposed dates for the meeting. At 116, the invited participants can optionally propose other dates. At 118, it is determined whether a date can be found. At 120, the criteria for selecting a date can be configured by the meeting organizer as part of the configuration of the meeting scheduling service. If no date can be found at 118, the meeting organizer is notified at 124 so that he can update the meeting information and propose new dates and, then, control flows back to 110. If a date can be found at 118, all the participants are notified at 122 of the selected date and the meeting is scheduled. At 126, the selected date can optionally be approved by the meeting organizer as part of the configuration of the service. At 128, the process of using the meeting scheduling service ends.

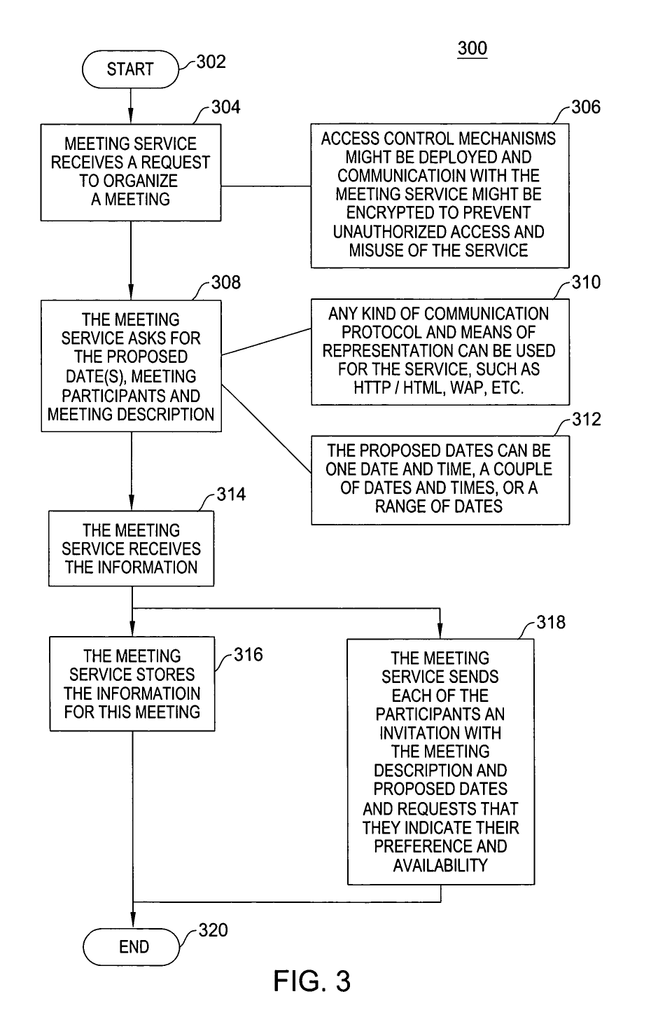

FIG. 3 illustrates an exemplary embodiment of a method 300 for processing a request to organize a meeting. At 302, the exemplary embodiment of the method 300 for processing the request to organize the meeting starts. At 304, the meeting service receives a request to organize a meeting. At 306, access control mechanisms might be deployed and communication with the meeting service might be encrypted to prevent unauthorized access and misuse of the service, in various embodiments. At 308, the meeting service asks for the proposed date(s), meeting participants, and meeting description. At 310, any kind of communication protocol and means of representation can be used for the service, such as HTTP, HTML, wireless application protocol (WAP), and the like, in various embodiments. At 312, the proposed dates can be one date and time, a couple of dates and times, or a range of dates. At 314, the meeting service receives the information. At 316, the meeting service stores the information for this meeting. At 318, the meeting service sends each of the participants an invitation with the meeting description and proposed dates and requests that they indicate their preferences and availability. At 320, the exemplary embodiment of the method 300 for processing the request to organize the meeting ends.

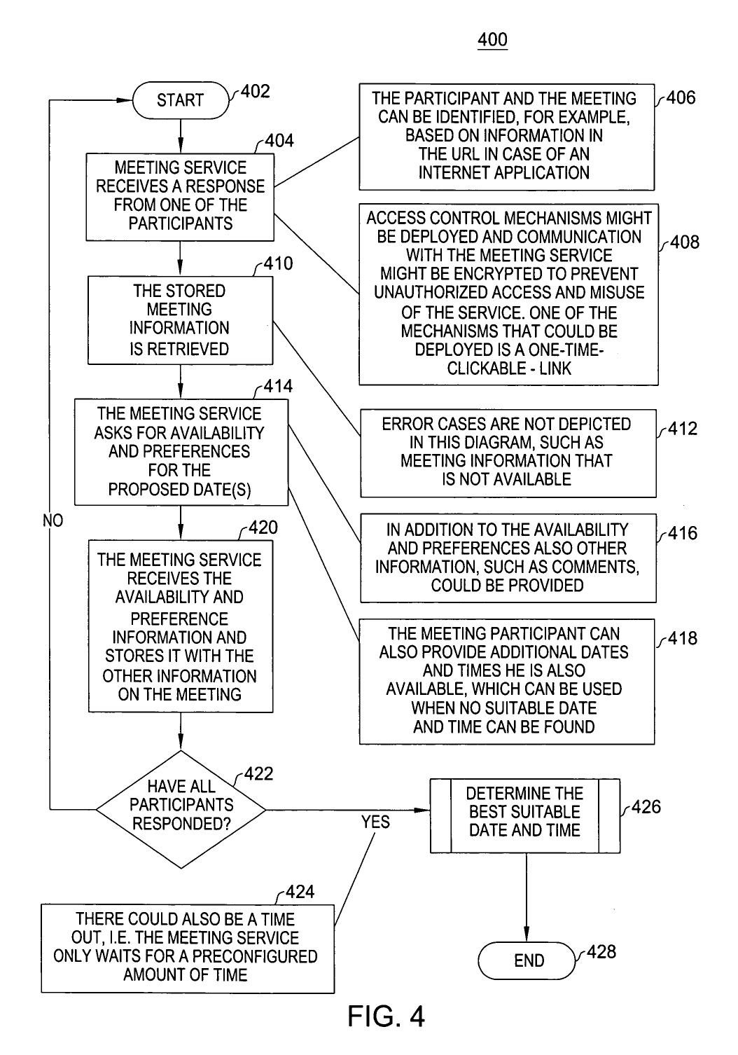

FIG. 4 illustrates an exemplary embodiment of a method 400 for processing a response from participants. At 402, the exemplary embodiment of the method 400 for processing the response from the participants starts. At 404, the meeting service receives a response from one of the participants. At 406, the participants and the meeting can be identified, for example, based on information in the uniform resource locator (URL) an exemplary embodiment implemented as an Internet application. At 408, access control mechanisms might be deployed and communication with the meeting service might be encrypted to prevent unauthorized access and misuse of the service in various embodiments. In one embodiment, the access control mechanism is a one-time clickable link. At 410, the stored meeting information is retrieved. Error cases are not depicted in this diagram 412, such as meeting information that is not available. In various embodiments, various error conditions are identified and handled. At 414, the meeting service asks for availability and preferences for the proposed date(s). At 416, in addition to the availability and preferences, other information, such as comments, are provided in various embodiments. At 418, the meeting participants can also provide additional dates and times that they are available, which can be used when no suitable date and time can be found in various embodiments. At 420, the meeting service receives the availability and preference information and stores it with the other information on the meeting. At 422, it is determined whether all of the participants have responded. If all of the participants have responded, the best suitable date and time is determined at 426. At 424, there could also be a time out in various embodiments, e.g., the meeting service could only wait for a preconfigured amount of time. At 428, exemplary embodiment of the method 400 for processing the response from the participants ends.

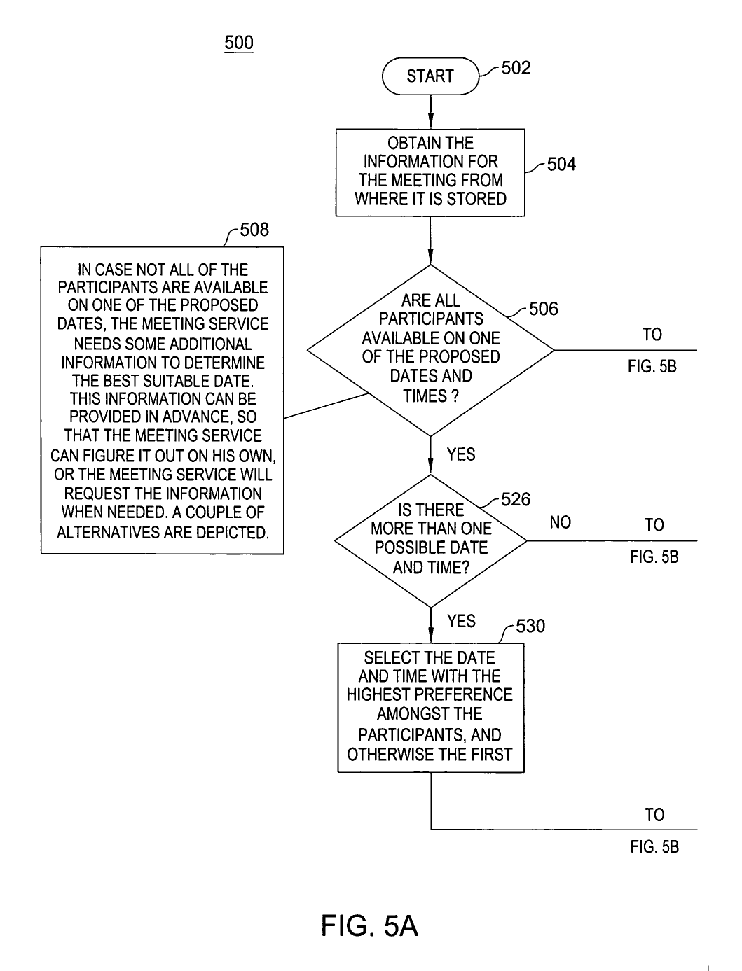

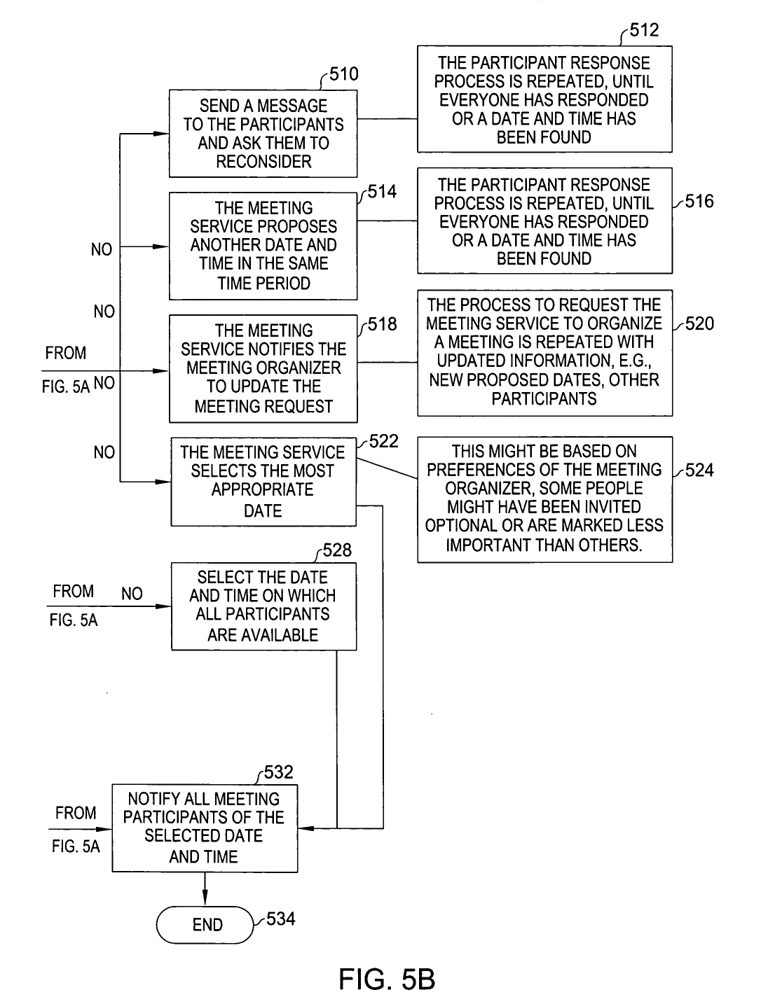

FIGS. 5A and 5B together illustrate an exemplary embodiment of a method 500 for determining the best suitable date and time. At 502, the exemplary embodiment of the method 500 for determining the best suitable date and time starts. At 504, the information for the meeting is obtained from a storage medium. At 506, it is determined whether all the participants are available on one of the proposed dates and times. At 508, when not all of the participants are available on one of the proposed dates, the meeting service needs some additional information to determine the best suitable date. This information can be provided in advance in various embodiments, so that the meeting service can determine the best suitable date or the meeting service can request any needed information. A couple of alternatives are depicted.

If not all of the participants are available at 506, several actions 510, 514, 518, 522 may be taken in various embodiments. At 510, a message is sent to the participants to ask them to reconsider and, at 512, the participant response process is repeated until everyone has responded or a date and time has been found. At 514, the meeting service proposes another date and time in the same time period and, at 516, the participant response process is repeated until everyone has responded or a date and time has been found. At 518, the meeting service notifies the meeting organizer to update the meeting request and, at 520, the method 300 for processing a request to organize a meeting (see FIG. 3) is repeated with updated information, e.g., new proposed dates or other participants. At 522, the meeting service selects the most appropriate date and, at 524, the most appropriate date might be based on preferences of the meeting organizer or whether some people might have been invited optionally or marked as less important than others.

If all of the participants are available at 506, then it is determined at 526 whether there is more than one possible date and time. If there is not more than one possible date and time at 526, then at 528, the date and time on which all participants are available is selected. If there is more than one possible date and time at 526, then at 530, the date and time with the highest preference among the participants is selected or, otherwise, the first date and time is selected. At 532, all meeting participants are notified of the selected date and time. At 534, the exemplary embodiment of the method 500 for determining the best suitable date and time ends.

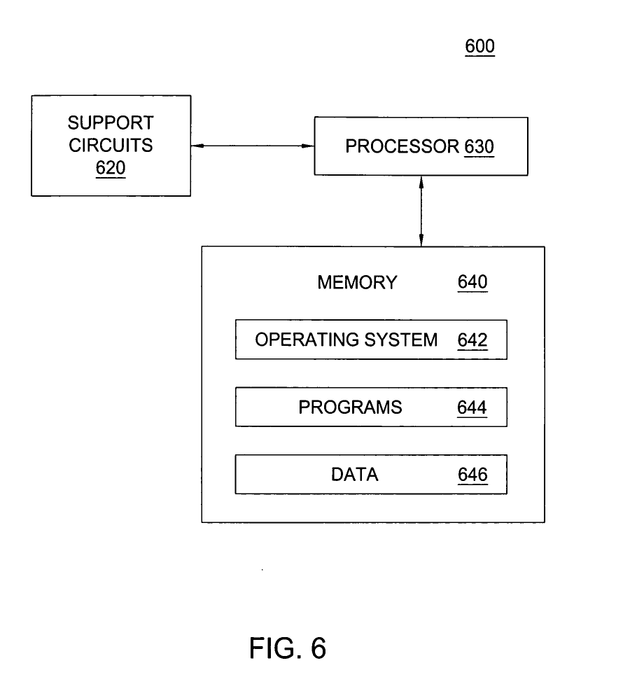

FIG. 6 is a high level block diagram showing a computer. The computer 600 may be employed to implement embodiments of the present invention. The computer 600 comprises a processor 630 as well as memory 640 for storing various programs 644 and data 646. The memory 640 may also store an operating system 642 supporting the programs 644.

The processor 630 cooperates with conventional support circuitry 620 such as power supplies, clock circuits, cache memory and the like as well as circuits that assist in executing the software routines stored in the memory 640. As such, it is contemplated that some of the steps discussed herein as software methods may be implemented within hardware, for example, as circuitry that cooperates with the processor 630 to perform various method steps. The computer 600 also contains input/output (I/O) circuitry that forms an interface between the various functional elements communicating with the computer 600.

Although the computer 600 is depicted as a general purpose computer that is programmed to perform various functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware, or a combination thereof.

The present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media or other signal bearing medium, and/or stored within a working memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for providing a meeting scheduling service, comprising:
receiving a request to schedule a meeting, at least one proposed date and time for the meeting, and at least one participant for the meeting;
sending invitations to the at least one participant; and
providing at least one best date and time for the meeting.

2. The method of claim 1, further comprising:
receiving information from the at least one participant.

3. The method of claim 1, further comprising:
timing out while waiting for information from the at least one participant.

4. The method of claim 1, wherein the request is received from a meeting organizer.

5. The method of claim 1, wherein the request is received from a storage medium.

6. The method of claim 1, further comprising:
providing notice that no suitable date and time exists for the meeting; and
receiving at least one new proposed date and time for the meeting.

7. The method of claim 1, further comprising:
providing notice that no suitable date and time exists for the meeting; and
sending at least one new proposed data and time for the meeting.

8. The method of claim 1, further comprising:
receiving criteria for selecting the at least one best date and time for the meeting.

9. The method of claim 1, further comprising:
receiving preferences for the meeting.

10. The method of claim 1, further comprising:
receiving approval of the best date and time for the meeting.

11. A system for providing a meeting scheduling service, comprising:
a processor to receive a request to schedule a meeting, at least one proposed date and time for the meeting, and at least one participant for the meeting, to send invitations to the at least one participant, and to provide at least one best date and time for the meeting; and
a storage device that is accessible by the processor to store the request, the at least one proposed data and time for the meeting, the at least one participant for the meeting, the information from the at least one participant, and the at least one best data and time for the meeting.

12. The system of claim 11, wherein information is received from the at least one participant.

13. The system of claim 11, wherein the processor times out while waiting for information from the at least one participant.

14. The system of claim 11, wherein the processor provides notice that no suitable date and time exists for the meeting and receives at least one new proposed date and time for the meeting.

15. The system of claim 11, wherein the processor provides notice that no suitable date and time exists for the meeting and sends at least one new proposed data and time for the meeting.

16. The system of claim 11, wherein approval of the best date and time for the meeting is received.

17. A computer readable medium storing instructions for performing a method for providing a meeting scheduling service, the method comprising
receiving a request to schedule a meeting, at least one proposed date and time for the meeting, and at least one participant for the meeting;
sending invitations to the at least one participant; and
providing at least one best date and time for the meeting.

18. The computer readable medium of claim 17, further comprising:
receiving information from the at least one participant.

19. The computer readable medium of claim 17, further comprising:
timing out while waiting for information from the at least one participant.

20. The computer readable medium of claim 17, further comprising:
providing notice that no suitable date and time exists for the meeting; and
sending at least one new proposed data and time for the meeting.
